(19) United States
(12) Patent Application Publication
(10) Pub. No.: US 2024/0067162 A1
(43) Pub. Date: Feb. 29, 2024

(54) PARKING ASSISTANCE SYSTEM

(71) Applicant: TOYOTA JIDOSHA KABUSHIKI KAISHA, Toyota-shi (JP)

(72) Inventors: Yuki MINASE, Toyota-shi (JP); Tsutomu MOCHIDA, Sunto-gun (JP); Keisuke OYAMA, Nisshin-shi (JP); Daiki MARUKI, Toyota-shi (JP); Yu HIEI, Nagoya-shi (JP)

(73) Assignee: TOYOTA JIDOSHA KABUSHIKI KAISHA, Toyota-shi (JP)

(21) Appl. No.: 18/212,760

(22) Filed: Jun. 22, 2023

(30) Foreign Application Priority Data
Aug. 25, 2022 (JP) 2022-133954

(51) Int. Cl. B60W 30/06; G06V 20/58

(52) U.S. Cl. CPC B60W 30/06; G06V 20/586; B60W 2420/42

(57) ABSTRACT

A parking assistance system includes: a non-on-board sensor that is able to acquire first information that is three-dimensional information of a first area including a target parking space being a target area in which an own vehicle is parked; an on-board sensor that is able to acquire second information that is three-dimensional information of a second area being a surrounding area of the own vehicle and constituting a part of the first area; and a control device configured to determine a route along which the own vehicle moves to the target parking space based on the first information and the second information and to control the own vehicle such that the own vehicle moves along the route.

### CROSS-REFERENCE TO RELATED APPLICATION

This application claims priority to Japanese Patent Application No. 2022-133954 filed on Aug. 25, 2022, incorporated herein by reference in its entirety.

### BACKGROUND

### 1. Technical Field

The present disclosure relates to a parking assistance system that automatically parks an own vehicle in a predetermined area.

### 2. Description of Related Art

A parking assistance system has been proposed in which a target (for example, a structure in a parking lot) around an own vehicle is recognized using an on-board sensor, a target parking space is determined based on a result of the recognition, and the own vehicle is automatically parked in the target parking space (see, for example, Japanese Patent No. 6412399 (JP 6412399 B)).

This type of the system (hereinafter referred to as a “conventional system”) determines a target parking space and a moving route from the current position to the target parking space based on information acquired from the on-board sensor on a public road in front of a parking lot at home. Then, the conventional system controls a drive device, a braking device, a steering device, etc. of the own vehicle such that the own vehicle moves along the moving route.

### SUMMARY

The conventional system determines (calculates) the target parking space and the moving route so as to avoid obstacles recognized by on-board sensors (ultrasonic sensors, cameras, etc.). For example, as shown in FIG. 6A, when the own vehicle is parked near the parking lot at home, the conventional system detects a target parking space PD1 and a first route R1 (the forward route indicated by the solid line and the rearward route indicated by the broken line). However, since the detectable range of the on-board sensor is relatively narrow, the recognition accuracy of the front portion of the parking lot of the obstacle (for example, the front end portion of the fence surrounding the parking lot indicated by the solid line) is high at this point. However, the recognition accuracy in a portion that is far from the above portion (portion indicated by dashed lines) is low. Therefore, there may be a case where the conventional system adopts the area that is actually interfering with the obstacle as the target parking space. Further, there may be a case where the conventional system adopts, as a moving route, a route in which the own vehicle interferes with the obstacle when the own vehicle is moved. In the example shown in FIG. 6A, the target parking space PD1 interferes with an overhang Pa of the parking lot.

The conventional system searches for the obstacle using on-board sensors in the process of moving the own vehicle along the moving route. As the own vehicle enters the parking lot and approaches the structure of the parking lot or the like, the accuracy of recognition of the target such as the obstacle increases. For example, as the own vehicle approaches the target, the sharpness of the image of the target acquired by the camera improves. Further, mesh-like fences made of wire rods, bar-shaped members, etc., short walls, etc., are less likely to reflect ultrasonic waves. Therefore, the recognition accuracy of these targets is low when the own vehicle is far away from these targets, but the recognition accuracy of these targets by the ultrasonic sensor increases as the vehicle approaches these targets. For example, as shown in FIG. 6B, when the rear portion of the own vehicle enters the parking lot, the conventional system can recognize the overhang Pa of the parking lot. When the conventional system recognizes a new target while the own vehicle is moving toward the target parking space and determines that there is a possibility of interference between the target and the own vehicle, the current target parking space and/or the moving route is discarded and a new target parking space and/or moving that can avoid the newly recognized target is set. For example, in the example shown in FIG. 6B, the conventional system sets a target parking space PD2 and a moving route R2. Then, the conventional system causes the own vehicle to move along the moving route R2 and parks the own vehicle in the target parking space PD2 (see FIG. 6C). As described above, the conventional system may reset the target parking space and/or the moving route each time an obstacle present in the parking lot is newly recognized, and it may take a long time to complete parking.

One of the objects of the present disclosure is to provide a parking assistance system capable of shortening the time required for automatic parking.

In order to achieve the above object, a parking assistance system (1) of the present disclosure includes: a non-on-board sensor (60) that is able to acquire first information that is three-dimensional information of a first area (PS) including a target parking space (PD) being a target area in which an own vehicle is parked; an on-board sensor (20) that is able to acquire second information that is three-dimensional information of a second area being a surrounding area of the own vehicle and constituting a part of the first area; and a control device (10) configured to determine a route (R) along which the own vehicle moves to the target parking space based on the first information and the second information and to control the own vehicle such that the own vehicle moves along the route.

As described above, in the conventional system, the target parking space and the moving route are set based on the information acquired from the on-board sensor (the information corresponding to the second information of the present disclosure). However, the range (angle and distance) in which the on-board sensor can acquire the information with high accuracy is relatively narrow. Therefore, the reliability (usefulness) of the set target parking space and moving route is low, and there may be a case where a new obstacle (target) is discovered (recognized) while the own vehicle is moving along the moving route. In this case, the target parking space and/or the moving route may need to be reset.

On the other hand, in the parking assistance system according to the present disclosure, the first information including the three-dimensional information of the first area including the target parking space (the three-dimensional information of the target present in the first area) is acquired by the non-on-board sensor and transferred to the control device. The control device sets the moving route based on the first information and the second information. Therefore, compared to the conventional system, the reliability (usefulness) of the target parking space and moving route set at the start of automatic parking is high. Accordingly, the situation of resetting the target parking space and/or the moving route while the own vehicle is moving along the moving route hardly occurs. With the above, the time required for automatic parking can be shortened compared to when the conventional system is used.

In the parking assistance system according to one aspect of the present disclosure, the control device specifies a position of the own vehicle with respect to the second area based on the second information, and specifies a position of the own vehicle with respect to the first area based on the position of the own vehicle with respect to the second area and a matching result between the first information and the second information, and determines the route based on the position of the own vehicle with respect to the first area and the first information.

According to this, the position of the own vehicle can be obtained with relatively high accuracy based on the second information. Then, a highly reliable moving route to the target parking space can be set based on the information representing the position of the own vehicle and the first information.

In the parking assistance system according to another aspect of the present disclosure, the non-on-board sensor is a mobile information terminal that is able to acquire polymetric video data, and the first information is generated based on the polymetric video data.

With the above, the first information can be generated relatively easily using a well-known terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a parking assistance system according to an embodiment of the present disclosure;

FIG. 2 is an overview diagram showing a scene of video shooting of a parking lot using a smartphone;

FIG. 3A is a plan view showing a process of setting a moving route;

FIG. 3B is a plan view showing the process of setting the moving route;

FIG. 3C is a plan view showing the process of setting the moving route;

FIG. 4 is a flowchart of a program for generating a map representing a three-dimensional model of a parking lot based on polymetric video data and transferring the map to the parking assistance ECU;

FIG. 5 is a flowchart of a program for setting the moving route and causing the own vehicle to move along the moving route;

FIG. 6A is a plan view showing a process of automatic parking by a conventional system;

FIG. 6B is a plan view showing the process of automatic parking by the conventional system; and

FIG. 6C is a plan view showing the process of automatic parking by the conventional system.

### DETAILED DESCRIPTION OF EMBODIMENTS

### Outline

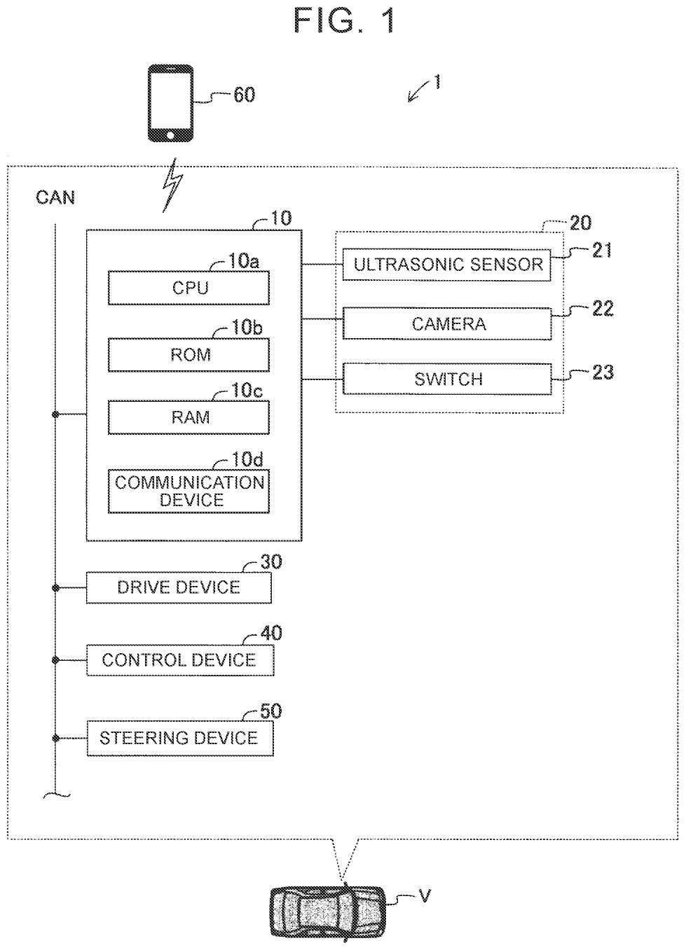

As shown in FIG. 1, a parking assistance system 1 according to an embodiment of the present disclosure is installed in a vehicle V (hereinafter referred to as “own vehicle”) provided with an autonomous driving function. The parking assistance system 1 has, for example, a function (parking assistance function) to automatically park the own vehicle in a parking lot PS at home.

### Specific Configuration

As shown in FIG. 1, the parking assistance system 1 includes a parking assistance electronic control unit (ECU) 10, an on-board sensor 20, a drive device 30, a braking device 40, a steering device 50, and a smartphone 60.

The parking assistance ECU 10 includes a microcomputer provided with a central processing unit (CPU) 10a, a read-only memory (ROM) 10b, a random access memory (RAM) 10c, and the like. Furthermore, the parking assistance ECU 10 includes a communication device 10d for wirelessly communicating with the smartphone 60 that will be described later.

The parking assistance ECU 10 is connected to other ECUs (for example, ECUs of the drive device 30, the braking device 40, and the steering device 50 that will be described later) via a controller area network (CAN).

The on-board sensor 20 includes a sensor that acquires information related to a target present around the own vehicle. For example, the on-board sensor 20 includes a sensor that acquires information (position, shape, size, color, pattern, etc.) on structures such as a wall and a fence of the parking lot PS.

Specifically, the on-board sensor 20 includes an ultrasonic sensor 21 and a camera 22.

The ultrasonic sensor 21 intermittently emits ultrasonic waves to the surrounding area of the own vehicle and receives ultrasonic waves (reflected waves) reflected by a three-dimensional object. The ultrasonic sensor 21 recognizes the distance between the own vehicle and the three-dimensional object, the relative position (direction) of the three-dimensional object with respect to the own vehicle, etc. based on the time from when the ultrasonic wave is transmitted until when the reflected wave is received, and transmits the recognition result (second information) to the parking assistance ECU 10.

The camera 22 includes imaging devices and an image analysis device. The imaging device is, for example, a digital camera equipped with a built-in imaging element of a charge coupled device (CCD) or a complementary metal oxide semiconductor (CMOS) image sensor (CIS). The imaging devices are installed on the front portion, the rear portion, the left side portion, and the right side portion of the own vehicle. The imaging device captures an image of a surrounding area of the own vehicle at a predetermined frame rate, and acquires image data. The imaging device transmits each image data to the image analysis device. The image analysis device analyzes the acquired image data and acquires information related to the target present around the own vehicle from the image. For example, the image analysis device recognizes the shapes and colors of the walls and fences of the parking lot PS, the pattern of the road surface, and the like, and transmits the recognition result (second information) to the parking assistance ECU 10.

Furthermore, the on-board sensor 20 includes a switch 23. The switch 23 is an operating device for the driver to request the start of automatic parking that will be described later. The switch 23 includes, for example, a push button type normally open switch device. The parking assistance ECU 10 monitors the ON-OFF state of the switch 23.

The drive device 30 applies the drive force to drive wheels among wheels (left front wheel, right front wheel, left rear wheel, and right rear wheel). The drive device 30 includes an engine ECU, an internal combustion engine, a transmission, a drive force transmission mechanism that transmits the drive force to the wheels, and the like. The internal combustion engine includes an actuator that drives a throttle valve. The engine ECU acquires information (control signal) representing the target drive force from another ECU (parking assistance ECU 10), and drives the actuator of the internal combustion engine based on the information. As described above, the drive force applied to the drive wheels is controlled. The drive force generated by the internal combustion engine is transmitted to the drive wheels via the transmission and the drive force transmission mechanism. Further, the engine ECU acquires information (control signal) related to the shift position of the transmission from another ECU, and drives the actuator of the transmission based on the information. As described above, the shift position of the transmission is controlled.

When the vehicle to which the parking assistance system 1 is applied is a hybrid electric vehicle (HEV), the engine ECU can control the drive force of the vehicle generated by either one or both of the “internal combustion engine and electric motor” as a vehicle drive source. Further, when the vehicle to which the parking assistance system 1 is applied is a battery electric vehicle (BEV), an electric motor ECU that controls the drive force of the vehicle generated by the “electric motor” as the vehicle drive source can be used instead of the engine ECU.

The braking device 40 applies a braking force to the wheels (brake discs). The braking device 40 includes a brake ECU, a brake caliper, and the like. The brake caliper includes an actuator that presses a brake pad against a brake disc. The brake ECU acquires information (control signal) representing a target braking force from another ECU, and drives the actuator of the brake caliper based on the information. Thus, the braking force applied to the wheels (brake discs) is controlled.

The steering device 50 controls the steering angles of steered wheels (left front wheel and right front wheel). The steering device 50 includes a steering ECU, a steering mechanism, and the like. The steering mechanism is a link mechanism including a knuckle arm, a tie rod, and the like. The steering device 50 further includes an actuator that drives the steering mechanism to change the steering angle. The steering ECU acquires information (control signal) representing a target steering angle from another ECU, and drives the actuator based on the information. As described above, the steering angle of the steered wheels is controlled.

The smartphone 60 includes a camera (imaging device) and a LiDAR (ranging device) that are non-on-board sensors. The smartphone 60 has a function of recording, as polymetric video data (first information), stereoscopic images (moving images) obtained by stereoscopically photographing surrounding targets using the camera and the LiDAR.

### Parking Assistance Function

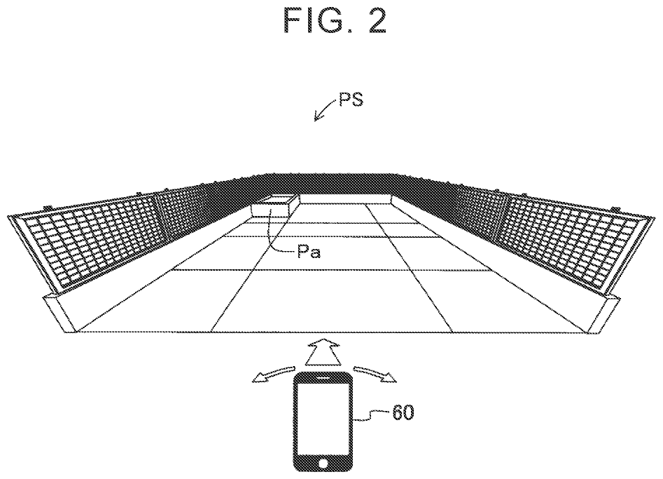

First, the driver (user) acquires polymetric video data of the parking lot PS (first area of the present disclosure) using the smartphone 60 as a preparation operation for using the parking assistance function. Specifically, as shown in FIG. 2, the driver (user) stereoscopically photographs the entire image of the parking lot PS as viewed from a public road near the parking lot PS, structures such as walls and fences of the parking lot PS, plants, and other targets in a state where the own vehicle is not parked in the parking lot PS. At that time, the driver (user) only needs to shoot the entire image of the parking lot PS, various targets, and the like while the driver (user) sets the camera of the smartphone 60 to a video shooting mode, activates the LiDAR, and moves with changing the direction of the smartphone 60. The parking lot PS shown in FIG. 2 has a rectangular shape in plan view. The outer periphery of the parking lot PS is composed of mesh fences. Further, a rectangular overhang Pa (for example, a flowerbed) is provided on one side surface of the parking lot PS.

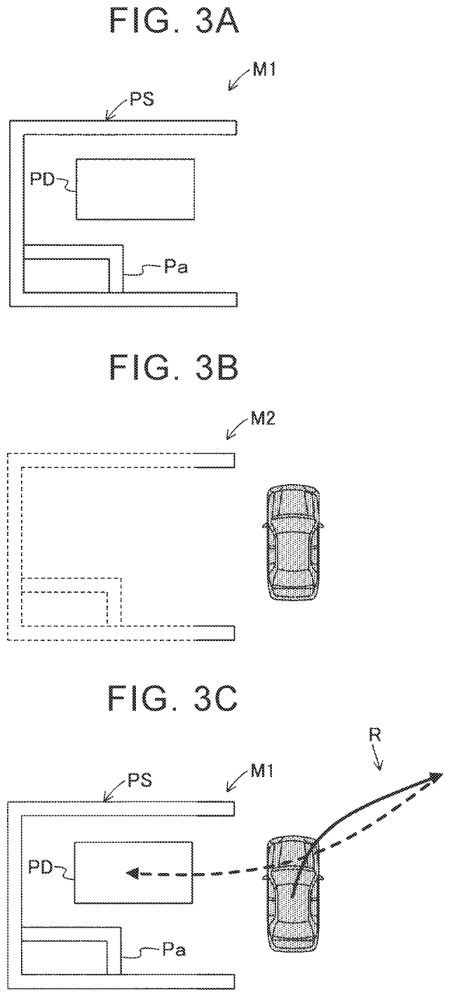

Next, the smartphone 60 then generates map M1 shown in FIG. 3A based on the polymetric video data. The map M1 includes data representing the area in which the own vehicle is to be parked (hereinafter referred to as “target parking space PD”). The target parking space PD is an area of the smallest rectangle that includes the own vehicle in plan view, in the area within the parking lot PS. This target parking space PD is set in an area within the parking lot PS in which a predetermined margin (a space where there is no three-dimensional object that interferes with the own vehicle) can be secured along the outer peripheral surface of the own vehicle. Note that the map M1 includes data (three-dimensional GIS data) representing the area occupied by each target in the parking lot PS. Further, the map M1 includes data (texture data) representing the color, pattern, etc. of the surface of each target.

When the range captured through video shooting by the smartphone 60 is narrow and information on the target included in the polymetric video data is too small, the reliability (usefulness) of the map M1 is low. Therefore, it is preferable for the driver (user) to shoot the video of the possible route from the public road near the parking lot PS to the target parking space PD and the surrounding area without omission (without interruption).

After the map M1 is generated, the smartphone 60 displays an image of the map M1 (three-dimensional model representing the configuration of the parking lot PS) on the display device. The driver (user) confirms that the three-dimensional GIS data and the texture data of each target constituting the parking lot PS are generated without omission while changing the display direction (viewpoint) of the three-dimensional model appropriately by operating the touch panel displayed on the display device of the smartphone 60. In particular, the driver (user) confirms that the three-dimensional GIS data and the texture data of the target in the area of the possible route to the target parking space PD and the surrounding area thereof are generated. When the data of some targets are missing, the driver (user) can perform video shooting of the parking lot PS again and regenerate the map M1, without adopting the current map M1. On the other hand, when the data of each target constituting the parking lot PS is generated without omission, the driver (user) transfers the map M1 to the parking assistance ECU 10 of the own vehicle via the wireless communication line. In principle, the driver (user) only needs to perform the above preparatory operation once. However, when the configuration of the parking lot PS is significantly changed after the map M1 is transferred to the parking assistance ECU 10, the driver (user) needs to perform the preparatory operation again.

When the parking assistance ECU 10 receives the map M1 from the smartphone 60, the parking assistance ECU 10 writes and stores the map M1 in the ROM 10b (flash ROM).

While the map M1 is stored in the parking assistance ECU 10, the driver temporarily stops the own vehicle in front of the parking lot PS and presses the switch 23. This starts automatic parking. Specifically, when the parking assistance ECU 10 detects that the switch 23 is pressed, the parking assistance ECU acquires data representing the recognition result of the targets present in the surrounding area of the own vehicle from the ultrasonic sensor 21 and the camera 22. Then, the parking assistance ECU 10 generates a map M2 similar to the map M1, as shown in FIG. 3B, for example, based on the data acquired from the ultrasonic sensor 21 and the camera 22. The parking assistance ECU 10 calculates the position and attitude of the own vehicle based on the data acquired from the ultrasonic sensor 21 and the camera 22, and reflects the calculation result on the map M2. Since the range that can be recognized by the ultrasonic sensor 21 and the camera 22 is relatively narrow, the recognition accuracy of the target near the entrance of the parking lot PS (the area indicated by the solid lines (a second area of the present disclosure)) on the map M2 is relatively high. However, the recognition accuracy of the target that is far from that (the area indicated by the dashed lines) is low. Therefore, it can be said that the map M2 represents only a partial area of the map M1.

Next, the parking assistance ECU 10 associates the target represented on the map M1 with the target represented on the map M2 (each object recognized by the on-board sensor 20) by performing pattern matching between the map M1 and the map M2. Then, the parking assistance ECU 10 calculates the current position and attitude of the own vehicle on the map M1 based on the pattern matching result. In other words, the parking assistance ECU 10 can complement the missing portion in the map M2 of the three-dimensional model representing the parking lot PS (the portion that is difficult to recognize only using the ultrasonic sensor 21 and the camera 22) with the map M1.

Next, the parking assistance ECU 10 sets (calculates) a moving route R (target trajectory of the center of gravity of the own vehicle) that allows the own vehicle to move to the target parking space PD while avoiding obstacles based on the map M1. In the example shown in FIG. 3C, the parking assistance ECU 10 sets the moving route R that avoids the overhang Pa and reaches the target parking space PD.

Next, the parking assistance ECU 10 sets a control signal pattern (time-series data of the control signals to be supplied to the drive device 30, the braking device 40, and the steering device 50, respectively) for moving the own vehicle along the moving route R.

Next, the parking assistance ECU 10 controls the drive device and the like in accordance with the control signal pattern to cause the own vehicle to move (forward/backward) along the moving route R and park the own vehicle in the target parking space PD. When the parking assistance ECU 10 determines that the own vehicle is parked in the target parking space PD, the parking assistance ECU 10 ends automatic parking.

The parking assistance ECU 10 cancels automatic parking when a predetermined cancellation condition is satisfied while automatic parking is being performed (in the course of moving the own vehicle in accordance with the control signal pattern).

For example, the parking assistance ECU 10 cancels automatic parking when a new obstacle is detected. Specifically, the parking assistance ECU 10 searches for obstacles using the ultrasonic sensor 21 and the camera 22 while causing the own vehicle to move along the moving route R. When the parking assistance ECU 10 detects a new obstacle that is not shown on the complemented map M1, the parking assistance ECU stops the own vehicle and cancels automatic parking. Then, the parking assistance ECU 10 causes the display device to display an image indicating that the obstacle is detected, and causes an audio system to reproduce a predetermined sound.

Further, for example, when the driver depresses the brake pedal during automatic parking, the parking assistance ECU 10 stops the own vehicle and cancels automatic parking.

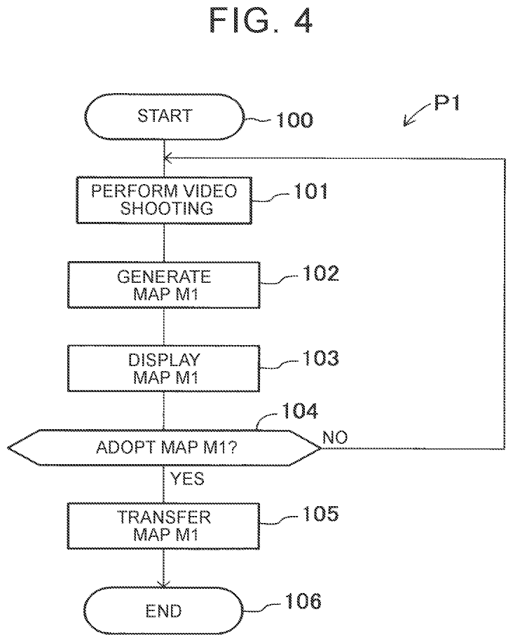

Next, with reference to FIG. 4, an operation of an arithmetic unit (hereinafter referred to as “CPUa”) of the smartphone 60 (a program P1 for executing the process of generating the map M1 and transferring the map M1 to the parking assistance ECU 10) will be specifically described.

The program P1 is downloaded from a predetermined server computer and installed in the smartphone 60. When the driver (user) taps the icon of the program P1 displayed on the display device of the smartphone 60, the CPUa starts the program P1 from step 100 and proceeds to step 101.

When the CPUa proceeds to step 101, the CPUa activates the camera and the LiDAR equipped on the smartphone 60. Further, the CPUa also displays a recording start icon on the display device of the smartphone 60. When the driver (user) taps the recording start icon, the CPUa starts recording (video shooting). The driver (user) performs video shooting (acquires polymetric video data) of the entire image of the parking lot PS, the structures of the parking lot PS, and the like. When the driver (user) taps a recording end icon, the CPUa ends recording and proceeds to step 102.

When the CPUa proceeds to step 102, the map M1 is generated based on the polymetric data acquired through video shooting described above. The CPUa then proceeds to step 103.

When the CPUa proceeds to step 103, the CPUa causes the display device of the smartphone 60 to display the map M1 (three-dimensional model of the parking lot PS). The CPUa then proceeds to step 104.

When the CPUa proceeds to step 104, the CPUa causes the driver (user) to select whether to adopt the map M1. Specifically, the CPUa causes the display device of the smartphone 60 to display icons (“Transfer” and “Do not transfer”) for selecting whether to transfer the map M1 to the parking assistance ECU 10. When the three-dimensional GIS data and the texture data of each target in the parking lot PS are generated, the driver (user) taps “Transfer”. On the other hand, when some target data are missing, the driver (user) taps “Do not transfer”. When “Transfer” is tapped (104: Yes), the CPUa proceeds to step 105. On the other hand, when “Do not transfer” is tapped (104: No), the CPUa returns to step 101. That is, in this case, the driver (user) performs video shooting of the parking lot PS again and regenerates the map M1.

When the CPUa proceeds to step 105, the CPUa transfers the map M1 to the own vehicle (parking assistance ECU 10) via the wireless communication line. Then, the CPUa proceeds to step 106 and ends execution of the program P1.

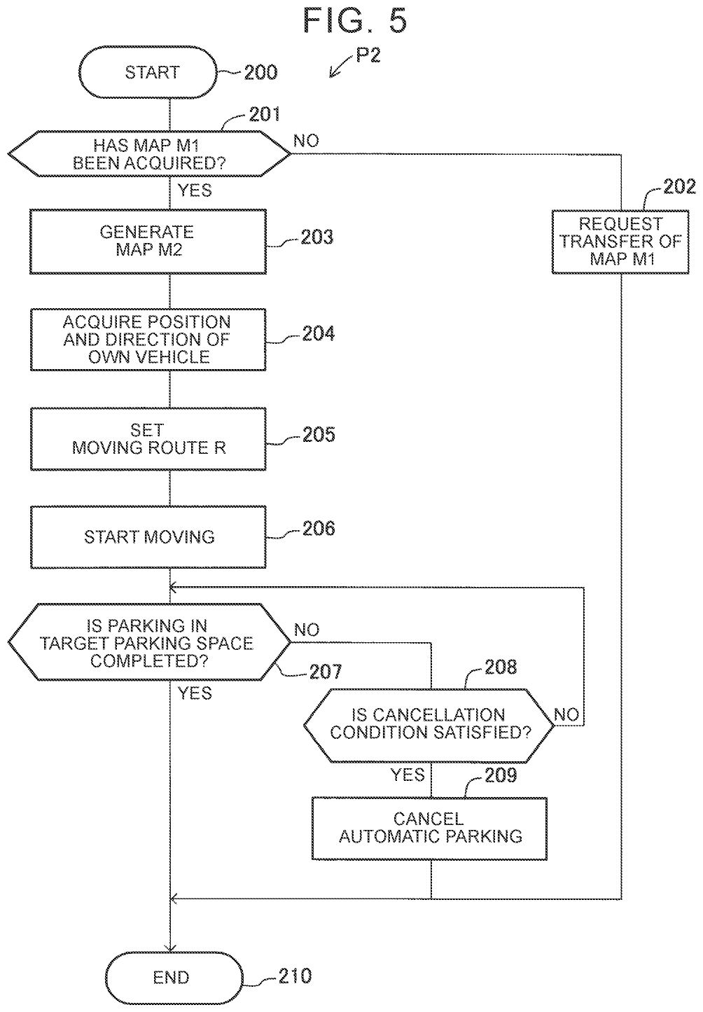

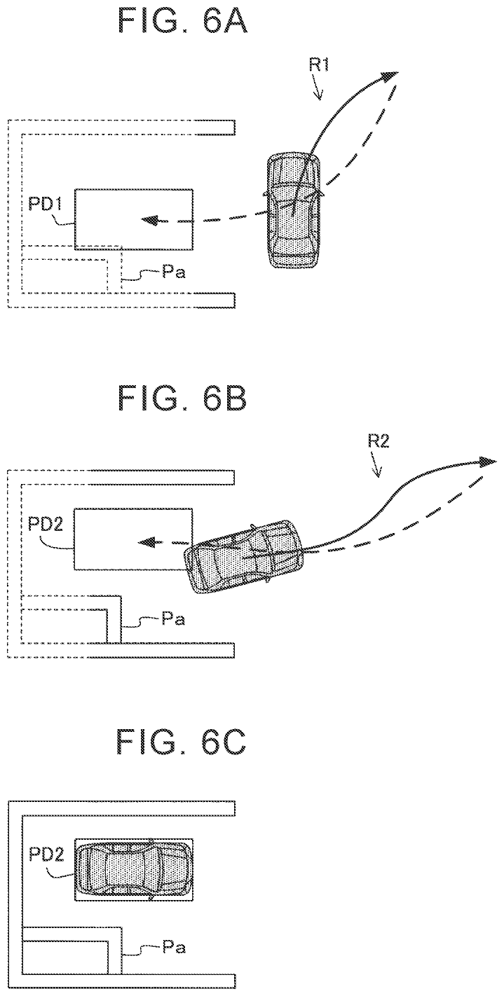

Next, with reference to FIG. 5, an operation (a program P2 for executing the process of automatically parking the own vehicle based on the map M1 and the map M2) of the parking assistance ECU 10 (hereinafter referred to as “CPUb”) will be specifically described.

When the CPUb detects that the switch 23 is pressed, the CPUb starts executing the program P2 from step 200 and proceeds to step 201.

When the CPUb proceeds to step 201, the CPUb determines whether the map M1 has been acquired from the smartphone 60. When the map M1 has been acquired (201: Yes), the CPUb proceeds to step 203. On the other hand, when the map M1 has not been acquired (201: No), the CPUb proceeds to step 202.

When the CPUb proceeds to step 202, the CPUb requests the driver (user) to transfer the map M1 from the smartphone 60. Specifically, the CPUb causes the display device provided in the own vehicle to display a predetermined image and causes the audio system to reproduce a predetermined sound. Then, the CPU proceeds to step 210 and terminates the execution of program P2.

After the CPUb proceeds to step 203, the CPUb generates the map M2 based on the information acquired from the ultrasonic sensor 21 and the camera 22. The CPUb then proceeds to step 204.

When the CPUb proceeds to step 204, the CPUb acquires the position and attitude of the own vehicle on the map M1 by performing pattern matching between the map M1 and the map M2. The CPUb then proceeds to step 205.

When the CPUb proceeds to step 205, the moving route R is set based on the map M1. The CPU then proceeds to step 206.

When the CPUb proceeds to step 206, the CPUb starts moving the own vehicle along the moving route R. The CPUb then proceeds to step 207.

When the CPUb proceeds to step 207, the CPUb determines whether parking of the own vehicle in the target parking space PD is completed. When parking of the own vehicle in the target parking space PD is completed (207: Yes), the CPUb proceeds to step 210 and ends execution of the program P2. On the other hand, when parking has not been completed yet (207: No), the CPUb proceeds to step 208.

When the CPUb proceeds to step 208, the CPUb determines whether the cancellation condition is satisfied. When the cancellation condition is satisfied (208: Yes), the CPUb proceeds to step 209. On the other hand, when the cancellation condition is not satisfied (208: No), the CPUb returns to step 207.

When the CPUb proceeds to step 209, the CPUb cancels automatic parking, proceeds to step 210, and ends execution of the program P2.

### Effects

In the conventional system, the target parking space and the moving route are set based only on the information acquired from the on-board sensor. Since the range in which information can be acquired with high accuracy by the on-board sensor is relatively narrow, the reliability (usefulness) of the target parking space and the moving route is low. Therefore, there may be a case where resetting of the target parking space and/or the moving route is required while the own vehicle is moving along the moving route. On the other hand, in the parking assistance system 1 according to the present embodiment, the high-precision map M1 (information on a wider range than the range that can be acquired by the on-board sensor 20) is generated in advance using the smartphone 60, and the map M1 is transferred to the parking assistance ECU 10. The target parking space PD is then determined based on the map M1. The parking assistance ECU 10 generates the map M2 based on information acquired from the on-board sensor 20 while the own vehicle is stopped near the parking lot PS. The parking assistance ECU 10 acquires the position and attitude of the own vehicle on the map M1 based on the matching result between the map M1 and the map M2. Then, the parking assistance ECU 10 sets the moving route R based on the map M1. Therefore, according to the parking assistance system 1, it is possible to set the target parking space PD and the moving route R with high reliability (usefulness) at the time of starting automatic parking. Therefore, the situation of resetting the target parking space and/or the moving route R while the own vehicle is moving along the moving route R hardly occurs. With the above, the time required for automatic parking can be shortened compared to when the conventional system is used.

The present disclosure is not limited to the above embodiment, and various modifications can be adopted within the scope of the present disclosure.

### First Modification

The map M1 may be generated using another information terminal (for example, a tablet-type computer device) as a non-on-board sensor, instead of or in addition to the smartphone 60 in the above embodiment. Alternatively, instead of or in addition to a mobile information terminal, a monitoring camera (security camera) installed in the parking lot PS may be used as a non-on-board sensor, and the map M1 may be generated based on the image acquired by the camera.

### Second Modification

The polymetric video data may be transferred from the smartphone 60 to the parking assistance ECU 10, and the parking assistance ECU 10 may generate the map M1 based on the data.

### Third Modification

In the above embodiment, the parking assistance ECU 10 starts executing the program P2 when the parking assistance ECU detects that the switch 23 is pressed. Alternatively, the parking assistance ECU 10 may start executing the program P2 when the parking assistance ECU detects that the own vehicle arrives near the parking lot PS using a well-known navigation system.

What is claimed is:

1. A parking assistance system comprising:
a non-on-board sensor that is able to acquire first information that is three-dimensional information of a first area including a target parking space being a target area in which an own vehicle is parked;
an on-board sensor that is able to acquire second information that is three-dimensional information of a second area being a surrounding area of the own vehicle and constituting a part of the first area; and
a control device configured to determine a route along which the own vehicle moves to the target parking space based on the first information and the second information and to control the own vehicle such that the own vehicle moves along the route.

2. The parking assistance system according to claim 1, wherein the control device specifies a position of the own vehicle with respect to the second area based on the second information, and specifies a position of the own vehicle with respect to the first area based on the position of the own vehicle with respect to the second area and a matching result between the first information and the second information, and determines the route based on the position of the own vehicle with respect to the first area and the first information.

3. The parking assistance system according to claim 1, wherein the non-on-board sensor is a mobile information terminal that is able to acquire polymetric video data, and the first information is generated based on the polymetric video data.
